(19) United States
(12) Patent Application Publication
(10) Pub. No.: US 2005/0083864 A1
(43) Pub. Date: Apr. 21, 2005

(54) System which enables a mobile telephone to be used to locate goods or services

(76) Inventor: Eithan Ephrati, London (GB)

Correspondence Address: Richard C Woodbridge Esq;Synnestvedt Lechner& Woodbridge, P O Box 592, Princeton, NJ, 08542-0592, US

(21) Appl. No.: 10/486,478

(22) PCT Filed: Aug. 12, 2002
(86) PCT No.: PCT/GB02/03715

(30) Foreign Application Priority Data
Aug. 10, 2001 (GB) 0119488.5

(51) Int. Cl. H04B 7/00; G06F 7/00; G06F 17/30; G06F 15/16

(52) U.S. Cl. 370/310; 709/201; 707/10

(57) ABSTRACT

A system which enables a mobile telephone to be used to locate goods or services, comprising the following elements: (a) a communications network to allow a mobile telephone operator to receive, from the mobile telephone, criteria defining the goods or services required; (b) a searching system connected to receive the criteria and perform automated searches against those criteria using resources provided by suppliers of the goods or services and to send results over the communications network to the mobile telephone; (c) an electronic commerce and billing engine operating to allow the user of the mobile telephone to order goods or services from the operator and not the supplier.

### BACKGROUND OF THE INVENTION

1. Field of the Invention

This invention relates to a system which enables a mobile telephone to be used to locate goods or services.

2. Description of the Prior Art

Mobile telephone operators, such as Vodafone plc, currently carry voice and data traffic from and to mobile telephones. The business of carrying voice and data traffic is however open to commoditisation as operators increasingly find it difficult to differentiate on meaningful quality comparisons, such as extent of coverage and voice quality.

One of the key lessons apparent from many successful internet business models is that, where previously customers dealt directly with a source of goods or services or with an existing intermediary, it can be more efficient to instead deal with a new, on-line intermediary. For example, many people previously bought airline tickets directly from an airline of choice or by visiting a travel agent. But over the past few years, many on-line travel services have been set up, such as Expedia.com, which act as new intermediaries. Expedia will locate airline tickets, holidays etc., which meet a user's criteria and will source these from many different suppliers. The basic relationship of trust, fundamental to a commercial relationship, becomes primarily between consumer and the new intermediary, with the brand importance of the ultimate service or goods supplier being diminished.

Mobile telephone operators have addressed the possibility of commoditisation of their services primarily through the mechanism of adding new data services for their customers in an attempt to maintain a relationship with their customers. This is a costly and uncertain process however. The objective of the present invention is to demonstrate an alternative and potentially far more potent strategy for mobile telephone operators.

### SUMMARY OF THE PRESENT INVENTION

In a first aspect of the present invention, there is a system which enables a mobile telephone to be used to locate goods or services, comprising the following elements:
(a) a communications network to allow a mobile telephone operator to receive, from the mobile telephone, criteria defining the goods or services required;
(b) a searching system connected to receive the criteria and perform automated searches against those criteria using resources provided by suppliers of the goods or services and to send results over the communications network to the mobile telephone;
(c) an electronic commerce and billing engine operating to allow the user of the mobile telephone to order goods or services from the operator and not the supplier.

Hence, the present invention envisages a technical infrastructure in which the mobile telephone operator is the trusted intermediary and supplier in commercial transactions. This has many practical advantages: first, it uses the mobile telephone operator's existing communication infrastructure with its customers; infrastructure re-use is especially important for 3G networks, which have to deliver very high useage in order to justify the costs incurred in developing them and obtaining spectrum.

Secondly, it allows mobile telephone operators to make greater use of their computerised billing systems and associated regular billing relationship with customers, allowing those customers to buy goods etc. and to have these costs added to the regular telephone bill. The mobile telephone operator may become in effect a credit source in the same way a major credit card company like America Express offers credit to consumers and routes payments to suppliers.

Thirdly, it allows the mobile telephone operators to become a trusted brand, extending that brand far beyond potentially commoditisable data and voice carrying and into a trusted source of a large range goods and services. It also allows the mobile telephone operator to secure competitive pricing and other commercial advantages by leveraging its huge customer base as a potential customer source.

So, a mobile telephone operator using an implementation of the present invention further increases consumer reliance by becoming a trusted and effective supplier of goods and services, reduces the threat of commoditisation, gains leverage over a large number of suppliers and develops a new source of revenue based on fees relating to transactions (e.g. 2% of the costs of goods etc.) and charges to consumers (e.g. interest on unpaid balances).

The term ‘mobile telephone operator’ used in this specification covers any entity whose primary role has historically been to carry voice or data traffic. It hence covers traditional mobile telephone operators, such as Vodafone, and also Internet Service Providers, such as Worldcom. The term ‘mobile telephone’ covers any device which can send data and/or voice over a long range wireless communication system, such as GSM, GPRS or 3G. It covers such devices in any form factor, including conventional telephones, PDAs, laptop computers, smart phones and communicators.

In a second aspect, there is a method of enabling a mobile telephone to be used to locate goods or services, comprising the following steps:
(a) a mobile telephone operator receives, from the mobile telephone, criteria defining the goods or services required;
(b) the mobile telephone operator then (i) directly or indirectly obtains from a supplier information describing one or more goods or services meeting the criteria and provides that information to the mobile telephone and (ii) allows the user of the mobile telephone to order goods or services directly from it and not the supplier.

In one implementation, a mobile telephone user sends a request for goods and services using a protocol which is device and bearer agnostic (i.e. is not specific to any one kind of device or bearer) over the wireless network operated by the operator (e.g. GSM, GPRS or 3G). The request is directed to the operator, who then routes it through to a server (typically operated by an independent company specializing in designing the software running on such servers, such as Cellectivity Limited), which initiates a search through appropriate suppliers (e.g. by using a web search agent). The search may depend on business logic set by the operator—e.g. it may be limited to suppliers who have entered into commercial arrangements with the operator. The relevant information is then returned over the wireless network operated by the operator to the consumer; the objective is for the consumer experience to be a highly simplified one, using predefined user preferences in order to make sure that the goods/services offered to the consumer are highly likely to appeal. When the consumer is presented with goods/services, which are acceptable, he can initiate the purchase from the operator and not the supplier using the mobile telephone by sending a request to the operator over the wireless network operated by the operator. The applicable costs will be added to his monthly telephone bill.

### BRIEF DESCRIPTION OF THE DRAWINGS

The present invention will be described with reference to the accompanying drawings in which:

FIGS. 1-21 show screen shots from a mobile telephone searching for and booking flight tickets using the system of the present invention;

FIG. 22 shows the process flow when using SMS to book flight tickets;

FIGS. 23-31 show screen shots from a mobile telephone searching for and buying a music CD;

FIGS. 32-45 show screen shots from a mobile telephone searching for and placing bets;

FIGS. 46-49 shows the process flow when using SMS to place bets;

FIGS. 50-60 show screen shots from a mobile telephone searching for a cinema film and book cinema tickets;

FIG. 61 shows the process flow when using SMS to search for a cinema film and book cinema tickets.

### DETAILED DESCRIPTION

The present invention will be described with reference to an implementation from Cellectivity Limited of London, United Kingdom.

Introduction

Current mobile Internet connectivity is based on point-to-point interaction between specific mobile-enabled sites or services (currently WAP or i-Mode) and the mobile end-user. The operator assumes its traditional role as the communications layer provider.

Cellectivity sets a new paradigm of wireless-internet interactivity. Within this new mode of interaction the operator/ISP/Portal becomes an enabler of access to Internet content and services, and the facilitator of information retrieval and commerce transactions.

All is done under ‘white label’; the operators/ISP/Portals uses its own brand name, thus maintaining the interface and ownership of its customers.

In addition Cellectivity provides the Operator/ISP/Portal with aggregated services via an application suite that overlies the Cellectivity commerce framework. This ensures that both Cellectivity and its customer get the best value and functionality. It also ensures that Cellectivity covers a broader spectrum of the wireless value chain, enhancing its appeal and share of the value chain.

High-Level Concept

Cellectivity's solution is an adaptable commerce-enabling framework that provides network operators, and ISP/Portal with the capability to allow their customers to firstly compare, and then purchase goods and services via their portal services, anytime and anywhere, and anyhow (pervasive computing).

As mentioned earlier, the approach of the framework and applications allows Cellectivity to cover a larger slice of the value chain, thus providing the operators/ISP/Portals with an underlying enabling technology that is marketed with its own global brand name, thus maintaining the interface and ownership of its customers, adding value to the user, and enhancing the appeal of the services through a trusted domain that is known to the end-user. Cellectivity thereby acts an enabler, and helps the operators/ISP/Portal to generate both additional traffic, and also additional revenue streams.

Cellectivity's framework offers secure, and reliable transactions between the end-user and merchants, by enticing users through simple, intuitive, and creative applications, which enable procurement of physical goods (including dynamic bidding and active off-line participation in auctions on behalf of the end user). In addition, it allows users to purchase services offered by multiple merchants, such as betting, auctioning, travel (ticketing), multi-source information gathering, money manager, location based deal finder, trader and financial services, by delivering accurate, and precise information to an end-user based upon a spontaneous request.

Cellectivity's framework, and applications are device agnostic, thereby allowing multiple device access, and designed from the ground-up for pervasive (anytime, anywhere, anyhow) commerce through the most popular access devices today and in the future, by utilising global industry standards such as WAP, XML, xHTML, Java, and i-Mode.

Cellectivity's framework provides Operators/ISP/Portals with this unique framework and infrastructure, thus enabling and leveraging on such an offering.

Cellectivity's framework is designed as a highly efficient and flexible middleware solution for distributing, caching, filtering, and managing information flows, between the Operators/ISP/Portals domain, the merchant and end-user.

The solution is based on an application server, which interacts with, and integrates three components that constitute real m-Commerce:
First, each application can access, interact with and act upon any web based service or content selected by an end-user.
Second, it communicates with the end-user in an effective, straightforward and minimal way, even when dealing with complex and sophisticated tasks.
And finally, it integrates with the operator's business logic, billing and profiling systems, to enable real control and ownership of the activity by the carrier.

Unlike current approaches, this application gateway does not serve only as a translator of protocols. Instead, it deploys applications that automate web processes (including password entry) on behalf of the end-user. On one end, these applications are launched by the user via a simple, minimalist, User Interface (UI), overcoming the problematic need for unnatural translation of web graphical user interface (GUI) into mobile GUI. On the other end each application can interact with any web site or service, to pursue complex tasks, eliminating the inherently non-scalable need to adjust each web service individually to a wireless protocol.

The behaviour of each application is dictated by two parameters; on one hand, the preferences and profile of the user (personalisation), and the other hand, the business rules (logic) that the carrier has set.

In addition it can feed the operator with a Transaction Data Records (TDR™) related to its activity (on behalf of the user). This puts the operators/ISP/Portals in a unique and attractive position, allowing powerful management of its customers, through data mining, and CRM since the TDRs define what its customers are interested in purchasing, how they go about looking and what goods/services are ultimately purchased and where bottlenecks or other hurdles arise that may cause a potential purchaser to lose interest in pursuing a purchase.

The service offering can coexist with the operators or ISP/Portals current framework, and other services, allowing a gradual transition, to the extent desired.

1.1 High-Level Framework Technology

Cellectivity's wireless application server is built of four tiers:
first tier consists the client's presentation layer (both for internet access and wireless access).
second tier is the web senrer presentation layer, in charge of interacting with the client.
third tier consists of the specific applications and the business logic.
fourth tier is made of both, the operator data and network information, and the data related to Cellectivity's functionality.

Both the second and third tiers are built on top of an Enterprise Java Bean (EJB) container to allow scalability of both the performance, and the deployment and implementation. Each application consists of a specific Java bean, and the solution includes a Software Development Kit (SDK) to allow rapid development of new applications. In addition the interaction with the Web is based on XML technology to make the application robust to changes over the Web. All components of the system can be accessed via XML to ease connectivity and integration with the operator and other applications.

The connectivity with the operator's systems allows an application to execute a transaction to completion under the brand name of the operator (of course the transaction may take place entirely within the web if desired).

Cellectivity has also developed unique agent-based automation software that allows the user to delegate tasks to its agents (searching, entering passwords to restricted access sites, providing other kinds of information which would normally be input manually) without the need for continued real time connection to the web. This capability can significantly improve the efficiency of interaction with the web, and makes many tasks, which are unfeasible with the current paradigm, available.

Appendix 1: Functional Specification

This Appendix 1 describes the ‘Shopping Toolkit’ application, covering the following mobile commerce functions:
Flight Search
CD Shopper
Betting
Cinema ticketing.
   2. Introduction

Cellectivity's solution will allow customers to search and purchase goods and services, anytime and anywhere. It offers secure, and reliable transactions between the end-user and merchants, by enticing users through creative, user-friendly shopping applications.

Cellectivity's solution is based on an application server, which interacts with, and integrates three components that constitute a complete m-Commerce circle.

First, each application can access, interact with and act upon any web based service or content selected by an end-user. Second, it communicates with the end-user in an effective, straightforward and minimal way, even when dealing with complex and sophisticated tasks. And finally, it integrates with the operator's business logic, billing and profiling systems, to enable real control and ownership of the activity by the carrier.

2.1 Purpose of this Document

This document represents the functional requirements of Cellectivity's Shopping Toolkit.

3. Scope

Flight Search—a complex task that involves input of a number of variables and a set of user preferences, resulting in a meaningful transaction cost.

CD Shopper—a useful application that finds the best price within a large number of items, involving medium transaction costs.

Betting Information—a popular application with minimal transaction fees but with significant expected usage. Also demonstrate the ability to cope with unusual and dynamic environments.

Cinema ticketing—an application that will enable users to porches cinema tickets from leading cinema chains via SMS and WAP.

3.1 Flight Details

The flight application will cover the following:

Route:

All destinations from any Ireland airport with the selected airlines.
   Sites/Airlines
British Midlands—www.britishmidland.com
Air Lingus—www.flyaerlingus.com
Ryan Air—www.ryanair.com.
   3.2 CD Shopper

The CD Shopper application will cover the following:

Sites

Amazon—www.amazon.co.uk
HMV—www.hmv.co.uk
Golden discs—wwv.goldendiscs.ie (Irish Site)
Tower records—wvw.towerrecords.co.uk
Dmgdirect—www.dmgdirect.com (Irish Site).
   3.3 Betting Information

The Betting Information application will cover the following:

Categories

Golf
Soccer.
   Sites
Paddy power—www.paddypower.com (Irish Site)
Luvbet—www.luvbet.com (Irish Site)
Hackett bet—www.hackettbet.com (Irish Site)
Ladbrokes—www.ladbrokes.com (UK Based)
William hill—www.williamhill.co.uk (UK Based).
   3.4 Cinema Ticketing

The ticketing application will cover two of the biggest cinema chains in the UK:
Warner Village: http://www.warnervillage.co.uk
Odeon: http://www.odeon.co.uk.

The user will be able to search for a film or for a cinema and to book the selected tickets, additionally the user will be able to view reviews for a selected film and get additional information on the cinema.

This spec cover the interface for VAP and for SMS.

3.5 Shopping Toolkit Home Page

The shopping assistant homepage is:
http://demo.cellectivity.com.
   3.5.1 Home Page Functionality

Every user that access the service for the first time will receive a password via WAP and SMS that is required for the login to the Shopping Assistant website. Using this password together with is mobile number (MSISDN) he will be able to enter his preferences setting on the web and to use all the additional services available online (SMS & WAP emulators).

First view screen is shown in FIG. 1.

Home page links are:

Book your flight
Betting
CD Shopper
Cinema ticketing.

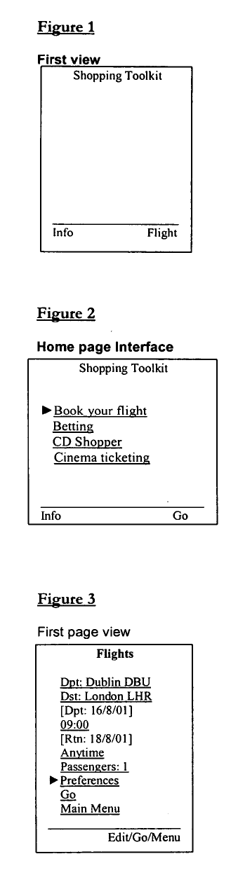

Home Page Interface screen is shown in FIG. 2

4. Functional Specifications—Flight Information

Flight Search Criteria

Select your departure and destination airport
Define date and time of flight (out and return)
Define number of tickets
Define user preferences:

Sort Order (Primary and Secondary)
By price
By Dates
By Airline.

Departure Airport
Select from a list of airports in Ireland.

Destination Airport
Select from a list of airports according to your departure place.

Airline (Combination of the Following)
Ryanair
British Midlands
Air Lingus
By Preferred weights*.

Time/Date Range
Define date and time range for the search
Plus/minus number of hours/days
To improve the search results the user will be able to select the level of importance of the different criteria (high medium and low).

The results of the search will be presented as follows:

First page
Departure and destination airport
Price
Out flight—date & time
Return flight—date & time
Airline
Number of tickets.

For every result it will be possible to view additional information for the out and return flights:
Price
Flight number
Airport of departure
Departure date and time
Arrival airport
Arriving date and time
Arriving airport
Number of passengers.
   4.1 Flight Details Functionality

4.1.1 First page view screen is shown in FIG. 3.

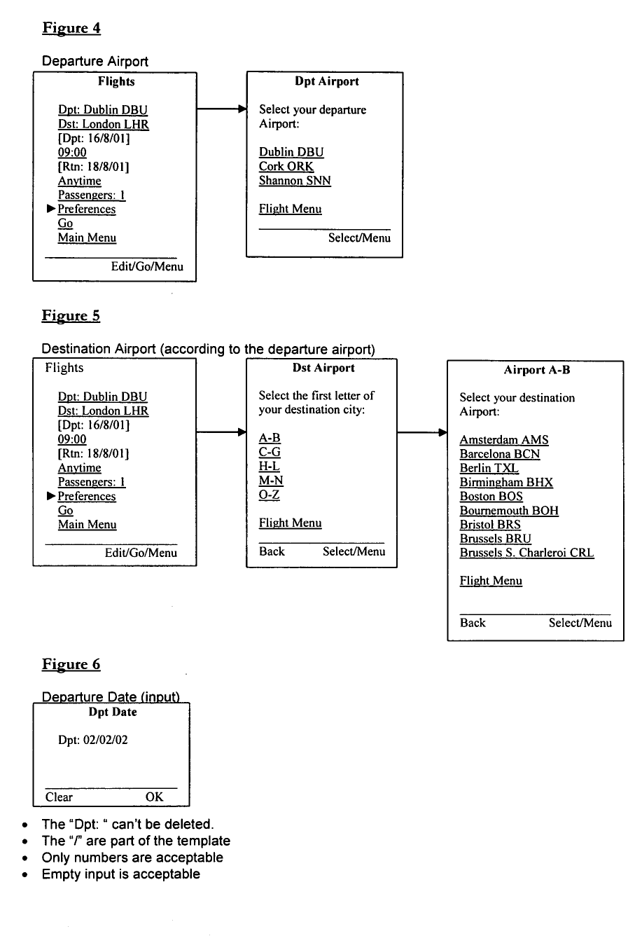

4.1.2 Departure Airport screen is shown in FIG. 4.

4.1.3 Destination Airport (according to the departure airport) screen is shown in FIG. 5.

4.1.4 Departure Date (input) screen is shown in FIG. 6.

4.1.5 Departure Time screen is shown in FIG. 7.

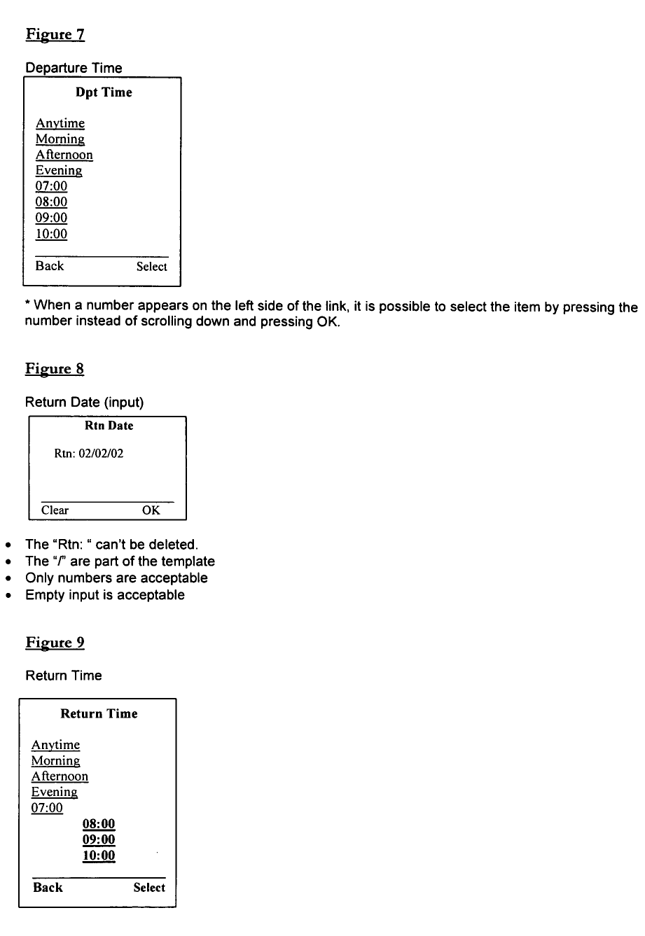

4.1.6 Return Date (input) screen is shown in FIG. 8.

4.1.7 Return Time screen is shown in FIG. 9.

4.1.8 Number Of Tickets screen is shown in FIG. 10.

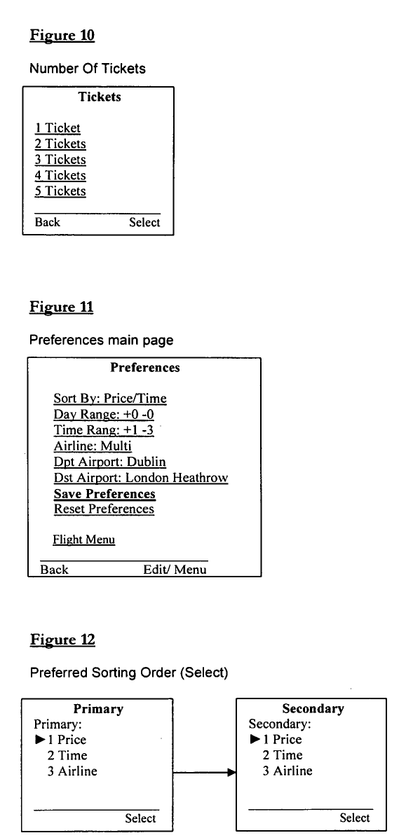

4.1.9 Preferences main page screen is shown in FIG. 11.

4.1.10 Preferred Sorting Order (Select) screens are shown in FIG. 12.

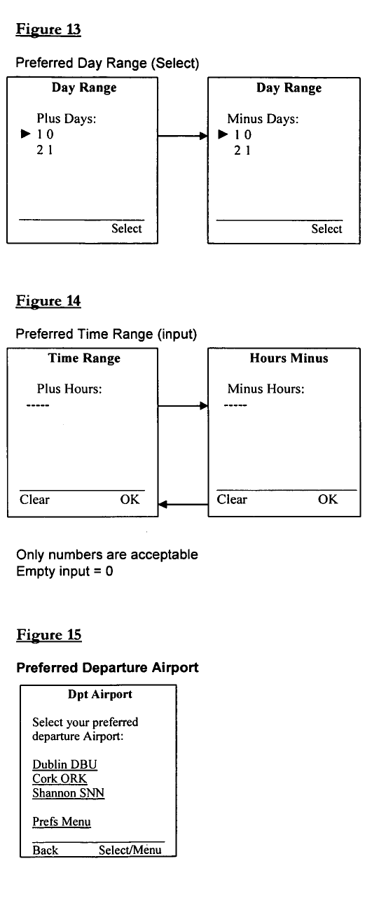

4.1.11 Preferred Day Range (Select) screens are shown in FIG. 13.

The Day Range preference will apply to the departure and the return day that have been selected on the main page.

4.1.12 Preferred Time Range (input) screens are shown in FIG. 14.

The time range preference vill apply to the departure and the return time that have been selected on the main page if the selection is a specific time. When selecting Anytime, Morning, Afternoon or evening the search will ignore the Time Range preference.

4.1.13 Preferred Departure Airport screen is shown in FIG. 15.

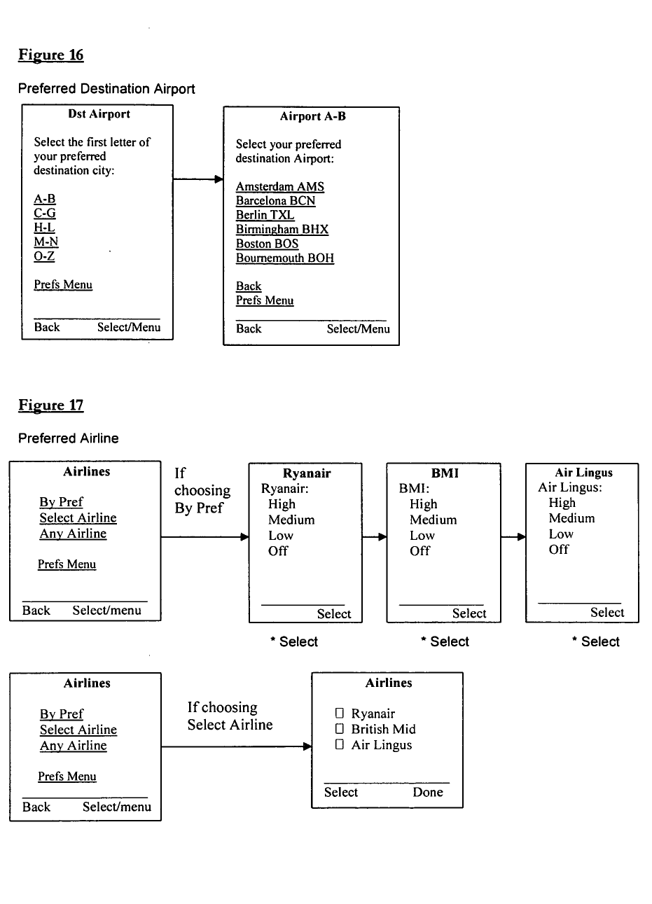

4.1.14 Preferred Destination Airport screens are shown in FIG. 16.

4.1.15 Preferred Airline screens are shown in FIG. 17.

4.1.16 Search Results

To cut down the amount of information in the first result page, only the main search criteria will be presented in it. The complete flight details will be presented on the More Info page.

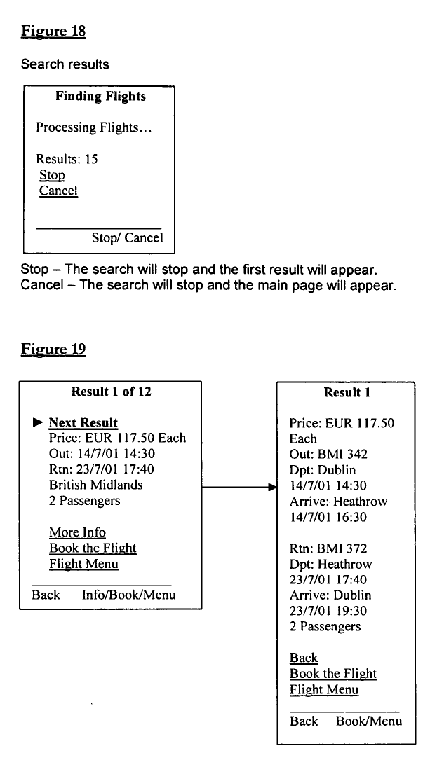

During the search the FIG. 18 screen will appear and show the search progress.

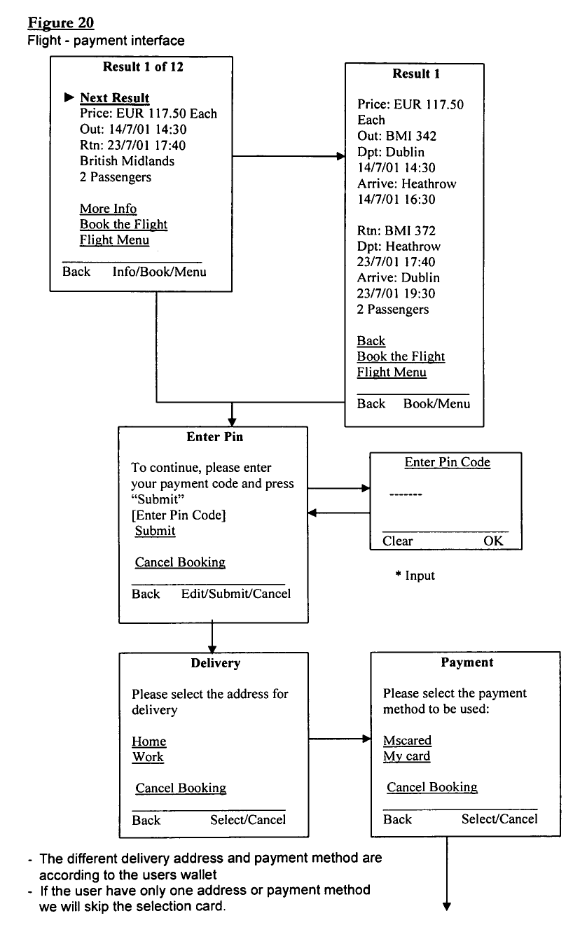

If none of the links are pressed, the first result will appear once the search is completed, as shown in FIG. 19.

4.2 Flight Payment Functionality

The flight application will include search and payment over vendors' sites. The application will search and present available flights according to the users' preferences. Once the user decides to buy the ticket the application will create an account for him on the vendor site (in sites that required to be a subscriber), and will complete the payment process on the user's behalf.

The payment functionality will be built out of three-steps.

a. The user will see the flight details and will enter his payment code to continue.

b. According to the number of tickets, the user will asked to enter the names of the passengers (and confirm the passenger name if there is only one).

c. The user will see all the available information from the HTML confirmation page and will press “Confirm” to complete the process.

d. We will show the user all the information from the confirmation page including reference number and send the user an e-mail with the details so if he wants, he could track his order on the vendors site.

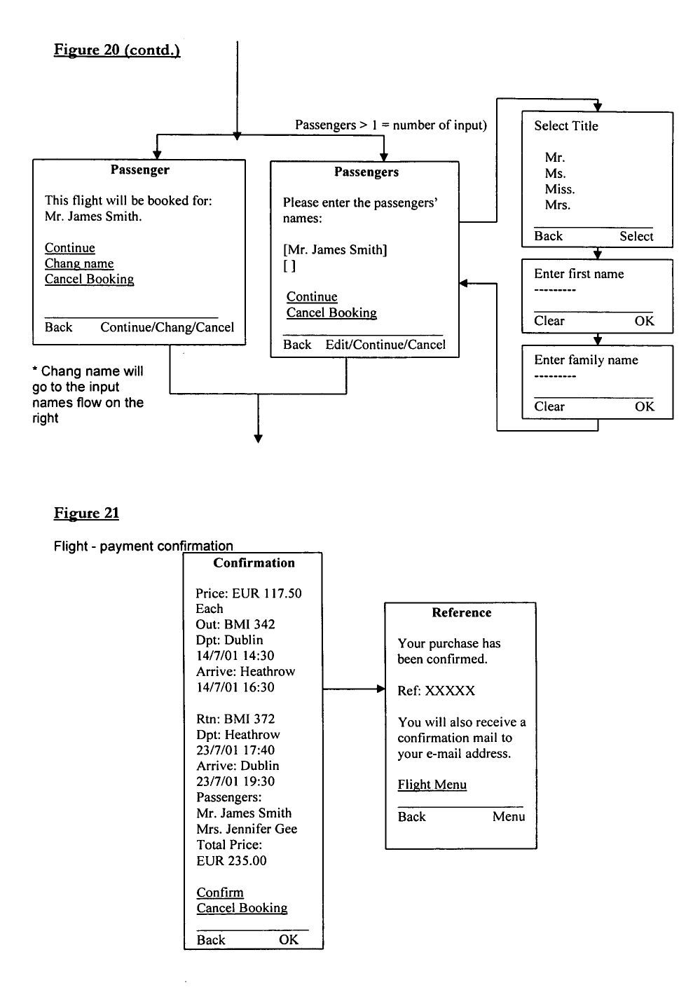

4.2.1 Flight—payment interface screens are shown in FIG. 20.

4.2.2 Flight—payment confirmation screens are shown in FIG. 21.

4.3 Flight—SMS Format

The SMS functionality will cover a regular search only, and will not support changes for the user preferences. The application will recognize the user and will use his saved preferences for the search.

Establish the Communication

The required data to initiate a search contains the following:
Departure date and time
Return date and time
Number of tickets.

The system should search for this information in the received SMS and return questions for missing data.

### EXAMPLE

Receive: flight
Reply: Edit form and reply “Flight #______ tickets Dpt date ______ at ______ Rtn date ______ at ______”
Receive: Edit form and reply “Flight 2 tickets Dpt date 2/2 at 16 Rtn date 15/2 at morning”
Reply: Flight #2 tickets Dpt date Feb. 2, 2002 at 16 Rtn date 15/02/2002 at morning. Reply: “Search” for results or edit to change search.

This loop will repeat until the user will send SEARCH.

Result

Result 1/14, EUR 111.37 Ryanair Dpt Feb. 2, 2002 16:50 Rtn 15/02/2002 06:55.
Reply: “Details”, “Book” or “Next”.
   Full Details
Receive: “Details”
Reply: EUR 111.37 2 ticket(s) Dpt Dublin FR 284 02/02/2002 16:50 arrive Stansted Feb. 2, 2002 18:00.
Rtn Stansted FR 203 15/02/2002 06:55 arrive Dublin 15/02/2002 08:05. Reply “Book”.
   After Book:
1. You requested 2 tickets to Stansted, Reply with Title, First name and Surname of each passenger: “Passengers: ______ ______ ______+______ ______ ______”
2. Receive: “Passengers: Mr Yuval Mekler+Mr Eithan Ephrati”
   Reply: Reply: “Confirm” or a corrected list. “Passengers: Mr Yuval Mekler+Mr Eithan Ephrati”
3 Receive: “Confirm”
   Reply: Confirm flight: Dublin to Stansted on Ryanair Dpt Feb. 2, 2002 16:50 Rtn 15/02/2002 06:55. 2 tickets, Total: EUR 222.74. Reply: “Confirm” or “Change”
4. Receive: “Confirm”
   Reply: You agreed to the Terms and Conditions and ticket restrictions expressed on Ryanair's website. To confirm please reply “PIN: ______” or “Cancel”.
5. Receive: “Pin: 1234”
   Your purchased has been confirmed. Confirmation No: 243ty6. You will also receive an e-mail confirmation. Thanks.

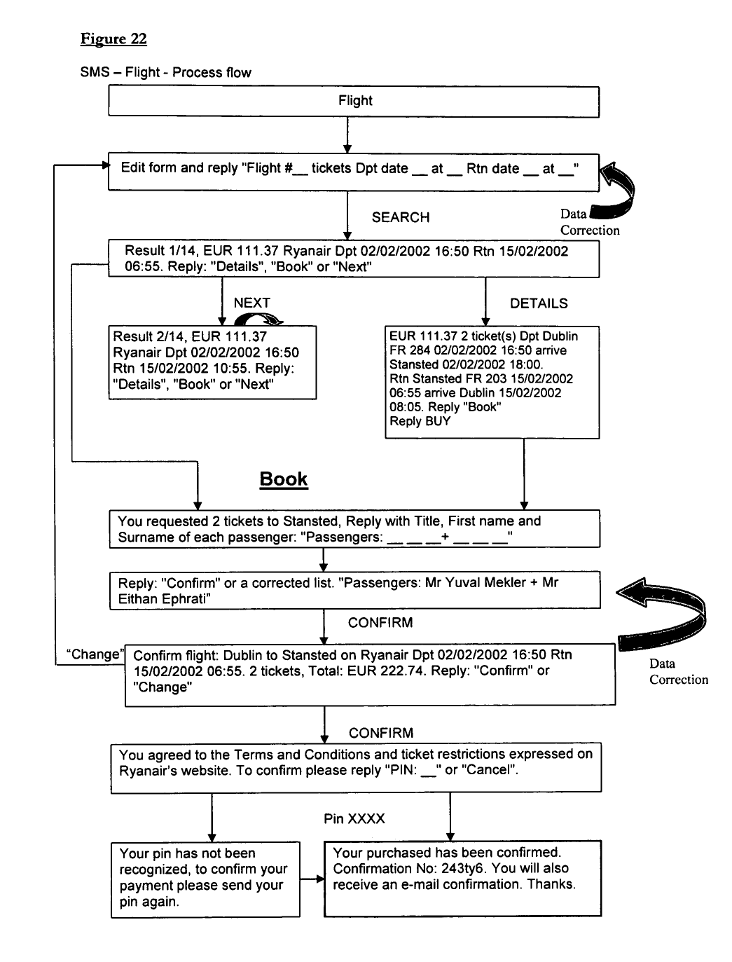

4.3.1 SMS—Flight—Process flow is shown in FIG. 22.

5. Functional Specifications—CD shopper

CD Search Criteria

Search by artist or band name
Search by album name
Top 30 album chart
Top 10 by categories
Define user preferences
Search favourites.

Search for the Users Favourite Bands

The user will be able to define a list of his favorite bands and store it. When searching for a CD he will be able to search directly for the albums of his favorite bands without the need to insert any additional information.
For any selected CD the application will search for the best price in the selected site.

The results of the search will be presented as follow:
Artist/Band name
Album name
Price
When receiving a result it will be possible to search for more albums by the same artist.
When selecting the buy option the user will receive the site name that sale the CD With the best price.
The user will receive a breakdown of the costs (CD, delivery and total cost)
All cost will be in EUR.
   5.1 CD Shopper Functionality

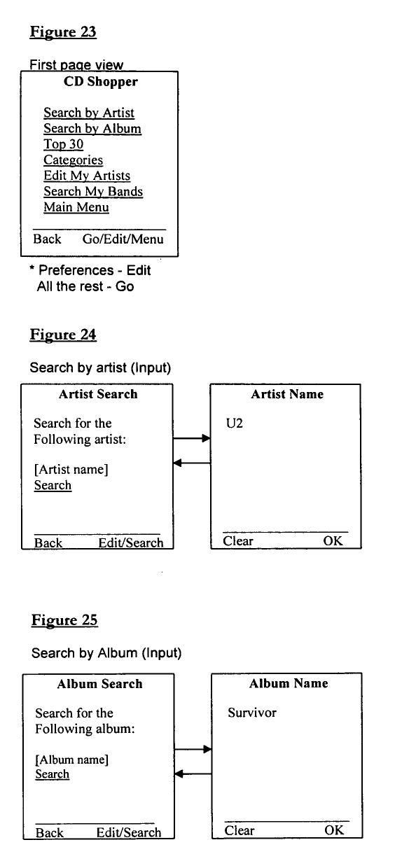

5.1.1 First page view is shown in FIG. 23.

5.1.2 Search by artist (Input) screens are shown in FIG. 24.

5.1.3 Search by Album (Input) screens are shown in FIG. 25.

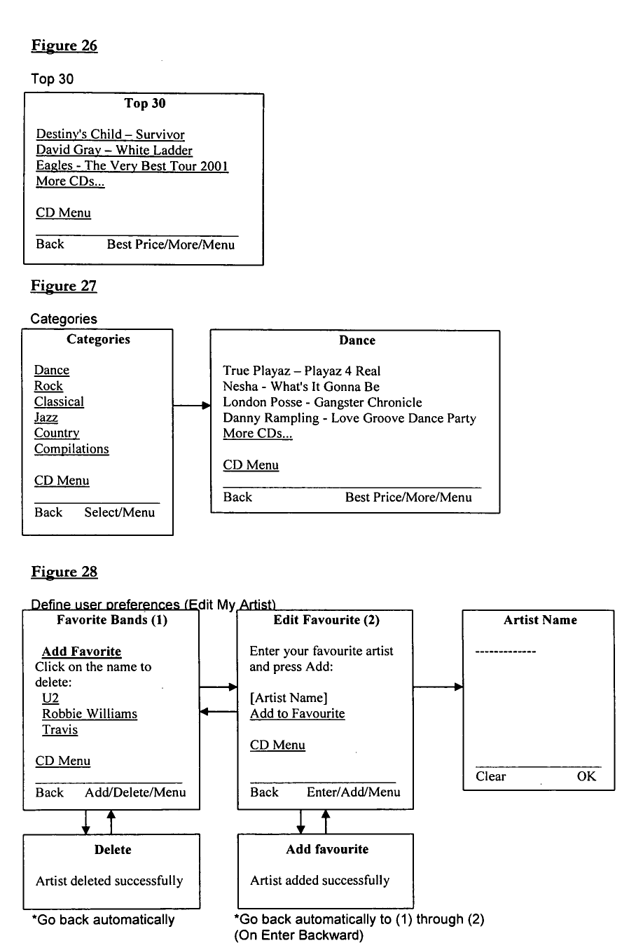

5.1.4 Top 30 screen is shown in FIG. 26.

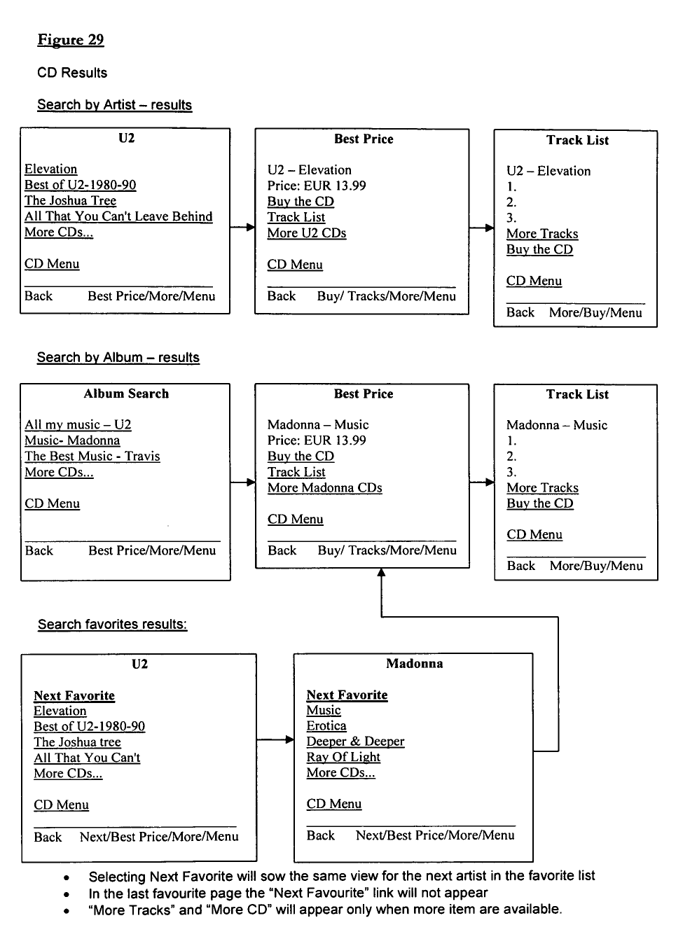

5.1.5 Categories screens are shown in FIG. 27.

5.1.6 Define user preferences (Edit My Artist) are shown in FIG. 28.

5.1.7 CD Results screens are shown in FIG. 29.

5.2 CD Payment Functionality

The CD application will include search and payment over vendors' sites. The application will search and present the best price for the selected CD from the proposed sites. Once the user decides to buy a CD the application will create an account for him on the vendor site (in sites that required to be a subscriber), and will complete the payment process on the user's behalf.

The payment functionality will be build out of two-steps.

a. The user will see the CD name (artist and album) and will enter his payment code to continue.

b. The user will see all the available information from the HTML confirmation page and will press “Confirm” to complete the process.

c. We will send the user an e-mail with the details so if he wants, he could track his delivery on the vendors site.

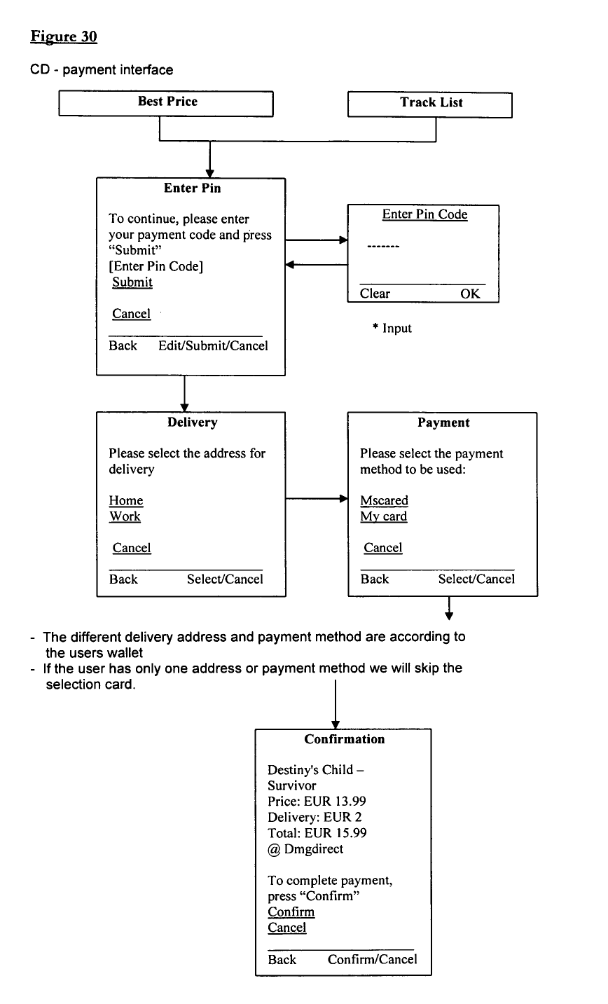

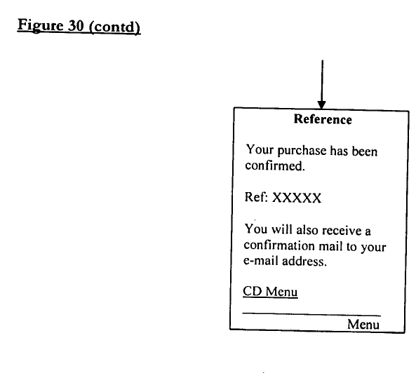

5.2.1 CD—payment interface screens are shown in FIG. 30.

5.3 CD Shopper—SMS Format

The SMS interface for CD Shopper will use the search function of the WAP interface.

The user will be able to send name of an artist or an album or the words CD and will get a reply accordingly.

Establish the Communication

The required data to initiate a search contains the following:
CD
CD By [Artist name]
CD [Album name]
CD [Album name] By [Artist name].

The system should search for this information in the received SMS.

### Example 1

Received: CD
Reply: To find a CD, reply:
“CD ______” for tide search
“CD by ______” for artist search
“CD ______ by ______” for tide and artist search.

### Example 2

Received: CD Loco
Reply: Loco by Fun Lovin' Criminals
Best price EUR 14.74 @ CDWOW
Reply: “PIN ______” to buy “TRACK” for track list or “NEXT” for next CD.

### Example 3

Received: CD by Madonna
Reply: Music by MADONNA
Best price EUR 14.74 @ CDWOW
Reply: “PIN ______” to buy “TRACK” for track list “NEXT” for next CD
Received: NEXT
Reply: Immaculate Collection by MADONNA
Best price EUR 14.74 @ CDWOW
Reply: “PIN ______” to buy “TRACK” for track list “NEXT” for next CD
   If the result is by the artist name, replying NEXT will reply the next match for the artist If the result is by album name, replying NEXT will reply the next match for the album name.

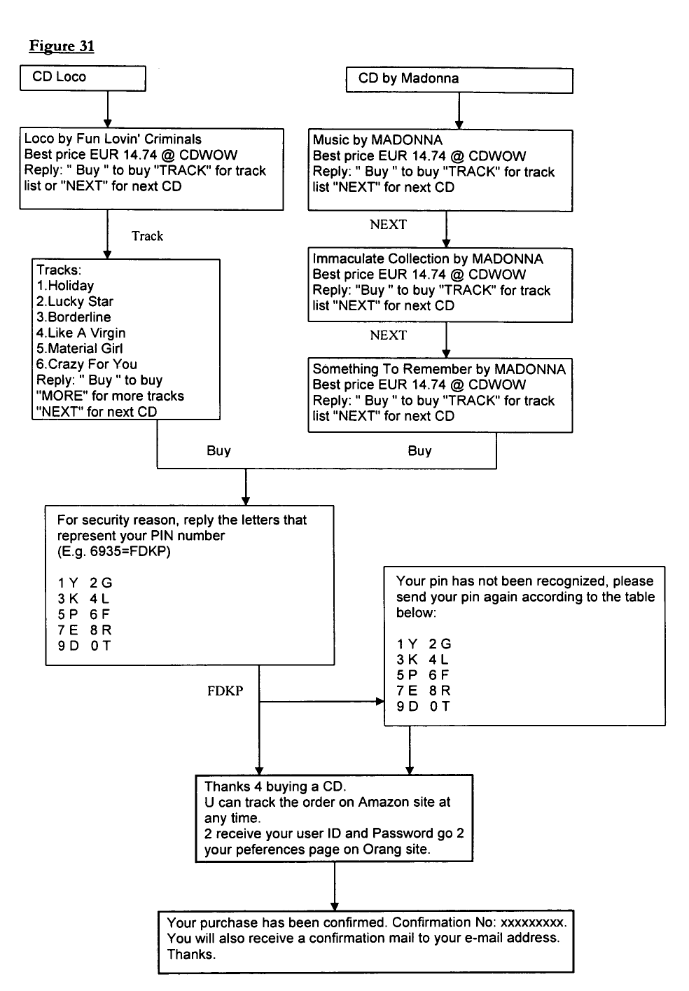

5.3.1 SMS—CD Shopper—Process flow is shown in FIG. 31.

6. Functional Specifications—Betting

The betting application will include betting on golf tournaments horseracing and soccer matches. The application will search and present the best odd for the selected bet from the proposed betting sites. Once the user decide to place a bet the application will create an account for him on the vendor site, will deposit the amount for the bet on his behalf and will place the bet. The application will also provide the user with his balance on the different vendor's sites and will allow the user to withdrew his balance.

6.1 Betting Functionality

6.1.1 Betting—General Functionality

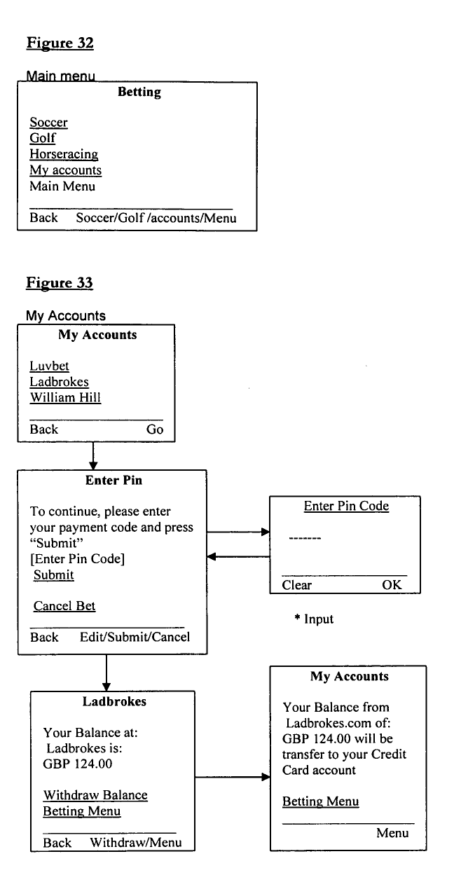

6.1.1.1 Main menu is shown in FIG. 32.

6.1.1.2 My Accounts screen is shown in FIG. 33.

6.1.2 Betting—Soccer Functionality

Soccer—Search Criteria

The application will return result for two types of bets.

1. Bets on the winner of a league, championship or cup where the bets are on the winner of the tournament and not on a specific match.

2. Bets on the winner of a match (who will win the mach) Home, Draw or Away.

Bets on League's Winner:

Select the preferred league
Receive best odds for each team to win the league.
   Bets on Match's Winner
Search for the preferred league
Select the match for a bet
Receive best odds for Home, Draw and Away
Define user preferences:

Search for the Users Favorite Team

The user will be able to define a list of his favorite teams and store it. When searching for a bet he will be able to search straight for a bet on his favorite teams without the need to insert any additional information.

The results of the search will be presented as follow:

Bets on League's Winner:

Tide: The selected league:
A list of all the teams with the odds for each team.
   Bets on Match's Winner
Tide: The selected match
Home—Best odd
Draw—Best odd
Away—Best odd.

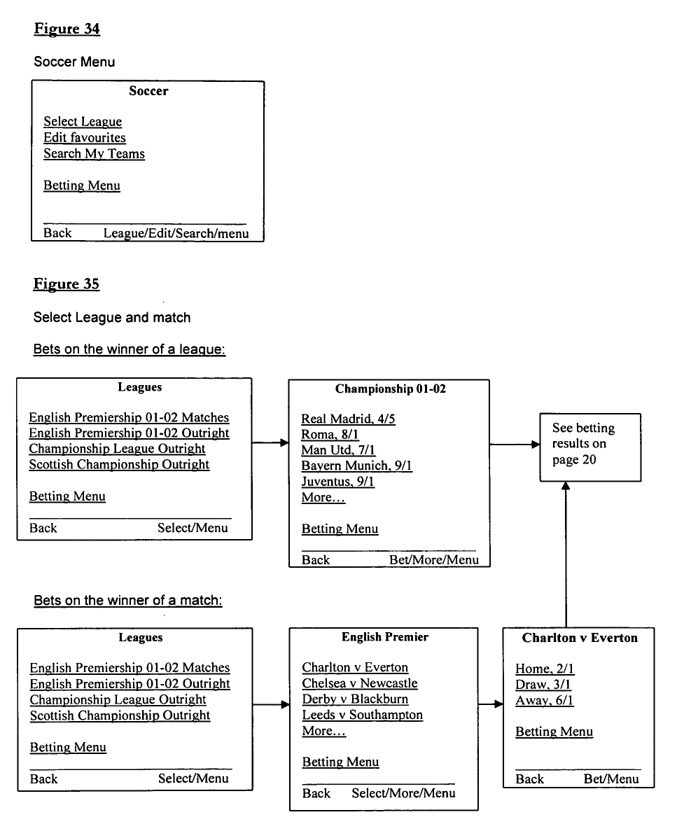

6.1.2.1 Soccer Menu is shown in FIG. 34.

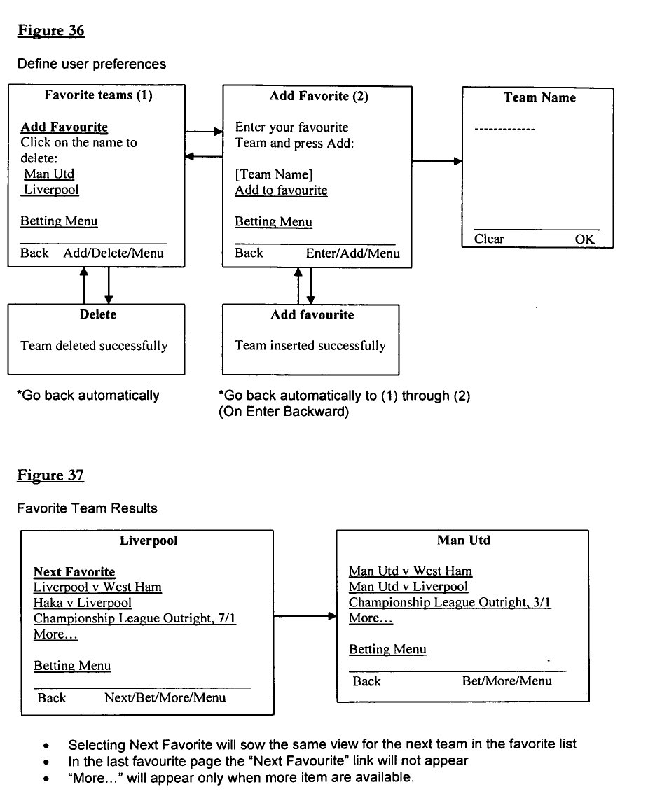

6.1.2.2 Select League and match screens are shown in FIG. 35.

6.1.2.3 Define user preferences screens are shown in FIG. 36.

6.1.2.4 Favourite Team Results screens are shown in FIG. 37.

6.1.3 Betting—Golf Functionality

Golf—Search Criteria

Bets on Tournament's Winner

Search for the preferred tournament
Receive best odds for each player to win the tournament
Define user preferences:

Search for the Users Favorite Player

The user will be able to define a list of his favorite players and store it. When searching for a bet he will be able to search straight for a bet on his favourite players without the need to insert any additional information.

The results of the search will be presented as follow:

Bets on League Winner:

Tide: The selected tournament name
List of players and the best odd for each player to win the tournament.
   Bets on Favorite Players:
Tide: The selected player
List of tournaments that the player is playing at and the best odd for him to win each tournament.

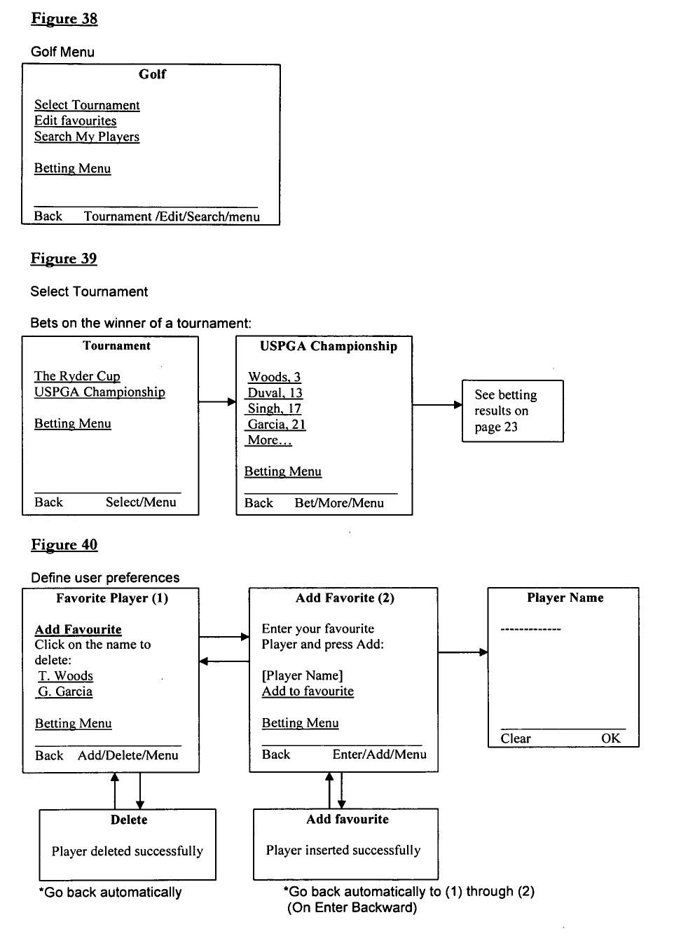

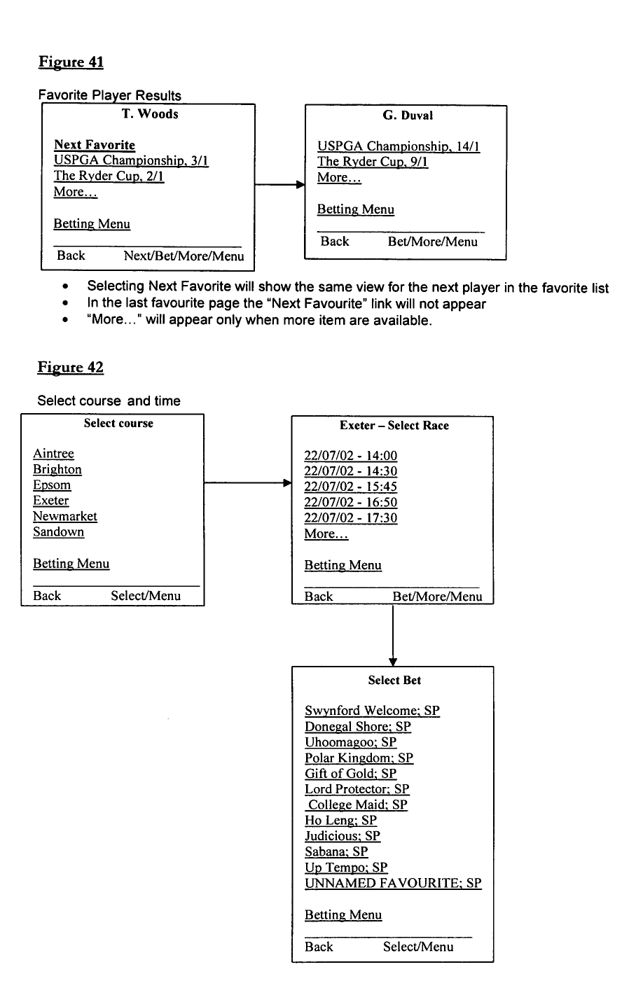

6.1.3.1 Golf Menu is shown in FIG. 38.

6.1.3.2 Select Tournament screens are shown in FIG. 39.

6.1.3.3 Define user preferences screens are shown in FIG. 40.

6.1.3.4 Favourite Player Results screens are shown in FIG. 41.

6.1.4 Betting—Horse Racing Functionality

Horse Racing—Search Criteria

The application will cover the winner of a race only.
Select the preferred course
Select the time of the race
Receive best odds for each horse to win the race.
   Search for the Users Favorite Team

The user will be able to define a list of his favorite horses and store it. When searching for a bet he will be able to search straight for a bet on his favorite horse without the need to insert any additional information.

6.1.4.1 Select course and time screens are shown in FIG. 42.

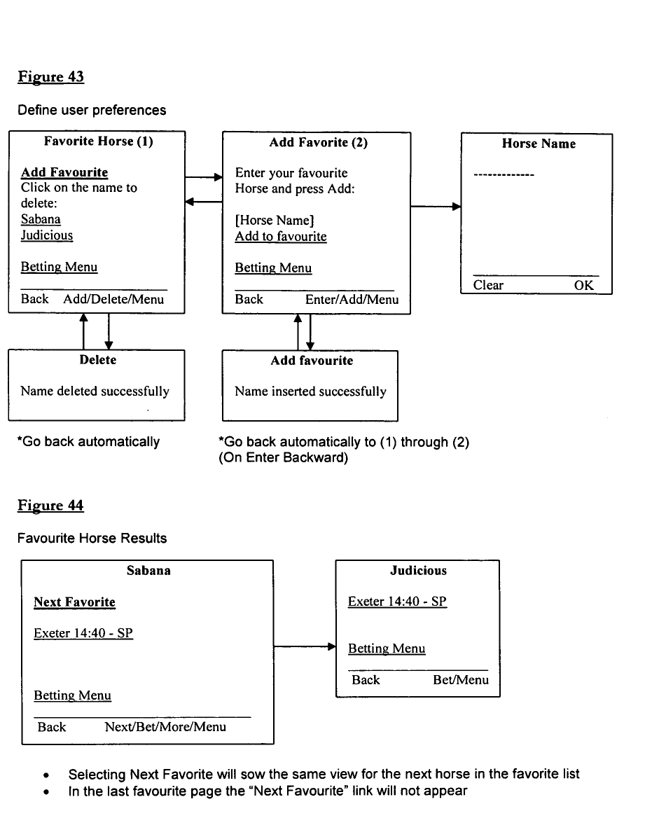

6.1.4.2 Define user preferences screens are shown in FIG. 43.

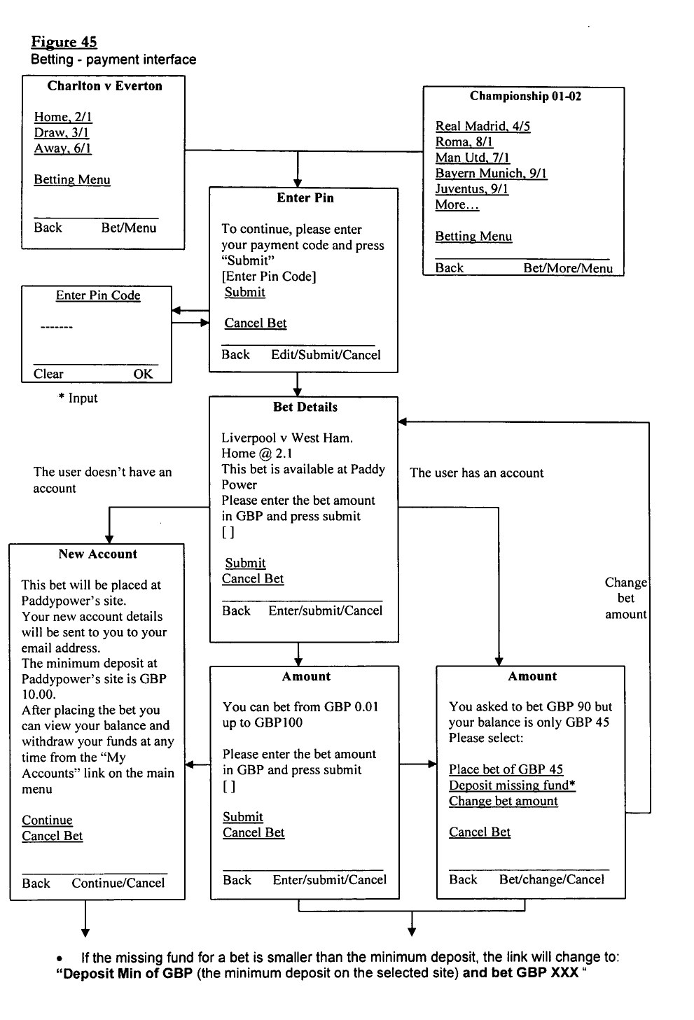

6.1.4.3 Favourite Horse Results screens are shown in FIG. 44.

6.2 Betting Payment Functionality

The betting application will include betting on golf tournaments and soccer matches. The application will search and present the best odd for the selected bet from the proposed betting sites. Once the user decide to place a bet the application will create an account for him on the vendor site, will deposit the amount for the bet on his behalf and will place the bet. The application will also provide the user with his balance on the different vendor's sites and will allow the user to withdrew his balance.

6.2.1 Betting—Payment Functionality

The payment functionality will cover the following:

Check if the user has an account on the vendor site.

If the User Don't have an Account:

Create an account for the user and save his user name and password.

Deposit the amount for the bet in the account.

Place the selected bet.

Send a confirmation to the user with the transaction and the bet details.

If the User have an Account:

User can use an account that he created previously on the web (he will have to enter his user name and password on the preferences site), or an account that was created previously by the application.

The application will show the user balance in the account and will ask for the amount of the bet.

a. The Balance on the Account is Higher the Required Bet

The application will place the bet without additional deposit.

b. The Balance on the Account is Lower the Required Bet

The application will notify the user that he required additional deposit and will place the bet according to his response.

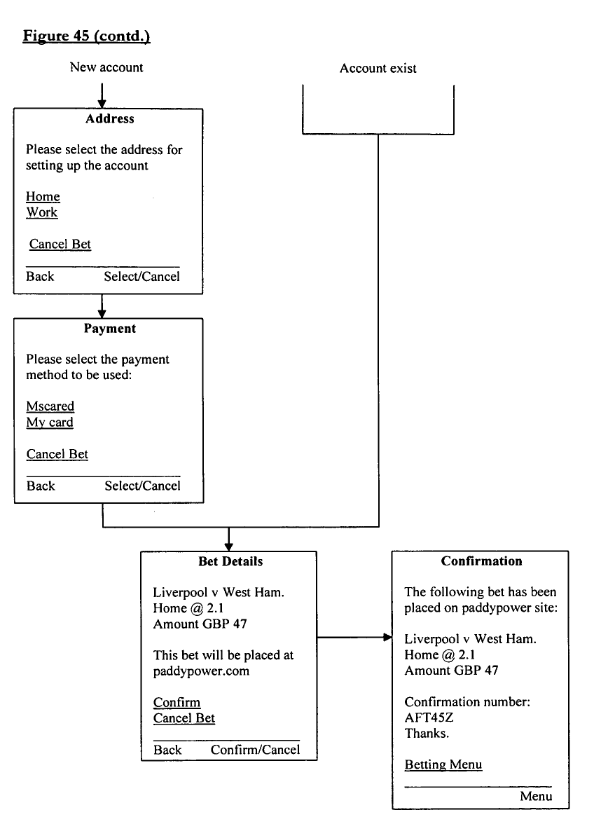

6.2.2 Betting—payment interface screens are shown in FIG. 45.

6.3 Betting—SMS Format

The SMS interface for betting will be similar to using the Search My Teams/Player/Horse function with WAP. The user will be able to send name of a team/player/horse or the words BET, BETTING, SOCCER, GOLF or Racing and will get a reply accordingly.

Establish the Communication

The required data to initiate a search contains the following:
“Betting”
“Soccer”, “golf” or “Racing”
Team/player/Horse [Name].

The system should search for this information in the received SMS.

### Example 1

Received: betting
Reply: Hello, to bet on golf player reply “Player ______”, to bet on a soccer team reply “Team ______”, to receive list of bets Reply “Soccer” or “Golf”.

### Example 2

Received: SOCCER
Reply: Hello, please reply “team [Name]” or: “League#______”
1 Eng Prem Matches
2 Eng Prem Outright
3 Cham's Outright
4 Scot's Prem Outright.

### Example 3

Received: GOLF
Reply: Hello, please reply: “Player [Name]” or: “League#______”
5 Us Masters
6 Euro order of merit.
   Results for Teams
Received: Team Liverpool
Reply:
Liverpool
Reply: “Bet ______ GBP on #______”:
1 Lose V Leeds, 13/10
2 Champions League Outright, 16/1
3 Win V Leeds, 13/8
Reply: “More” for more results.
Received: More
Reply:
Liverpool
Reply: “Bet ______ GBP on #______”:
4 English Premiership 2001-2002 Outright, 15/2
5 Draw V Leeds, 11/5.
   Results for League (Matches)
Received: LEAGUE 1
Reply:
English Premiership 2001-2002 Matches
Reply: “Match #______”
1 Leicester V Chelsea
2 Everton V Ipswich
3 Leeds V Liverpool
Reply: “More” for more results.
Received: More
Reply:
English Premiership 2001-2002 Matches
Reply: “Match #______”
4 Man Utd V Sunderland
5 Arsenal V Southampton
6 Newcastle V Bolton
Reply: “More” for more results.
   Results for League (Outright)
Received: LEAGUE 2
Reply:
English Premiership 2001-2002 Outright
Reply: “Bet ______ GBP on #______”
1 Chelsea, 22/1
2 Leeds, 14/1
3 Man Utd, 8/11
4 Arsenal, 9/4
Reply: “More” for more results.
Received: More
Reply:
English Premiership 2001-2002 Outright
Reply: “Bet ______ GBP on #______”
5 Newcastle, 16/1
6 Liverpool, 15/2.

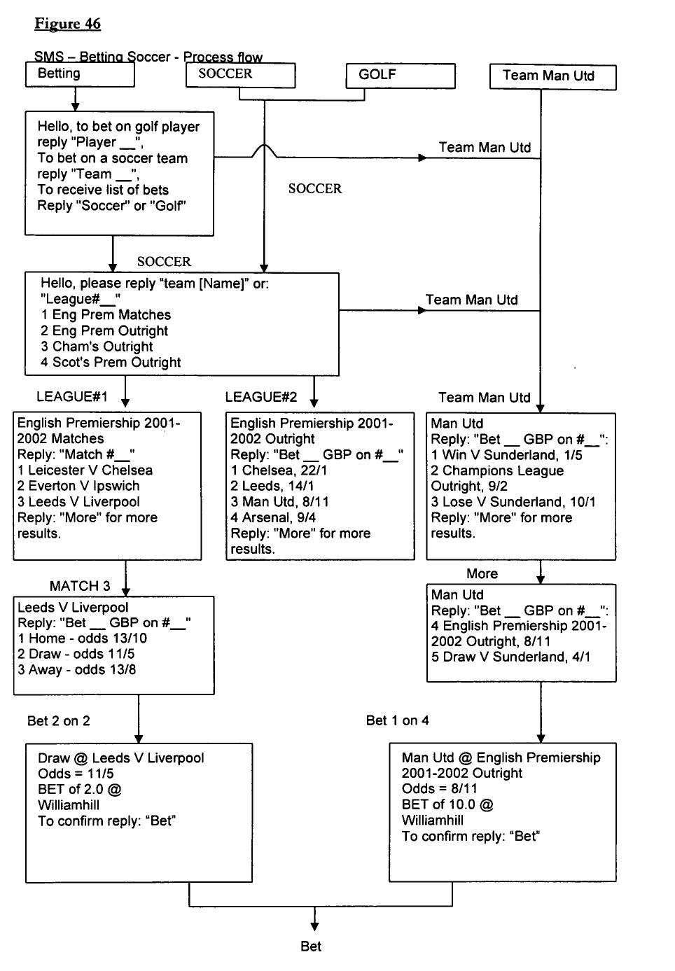

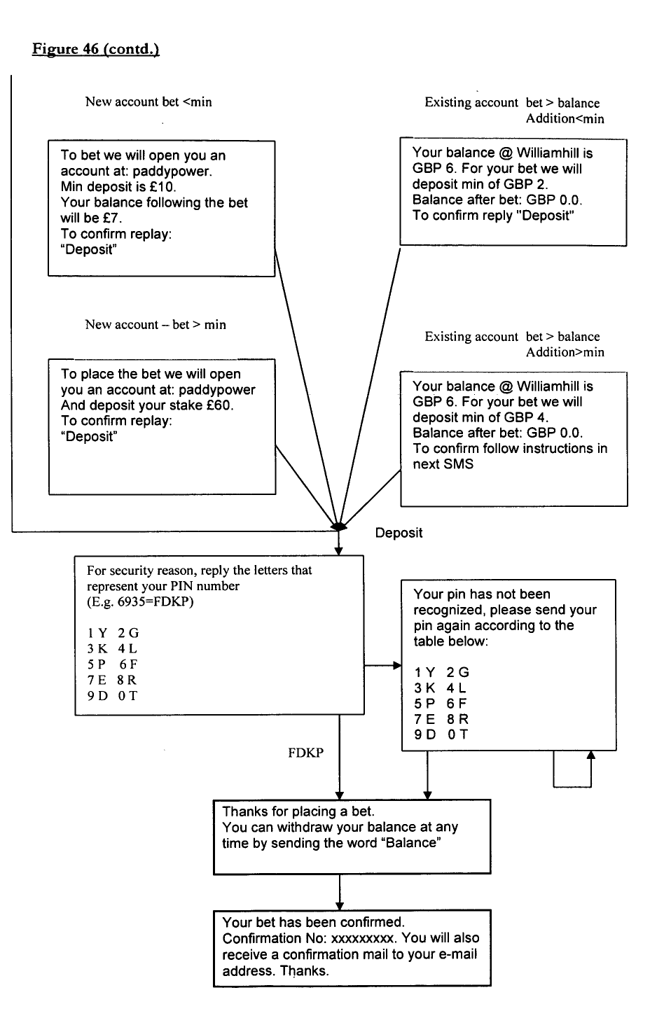

6.3.1 SMS—Betting Soccer—Process flow is shown in FIG. 46.

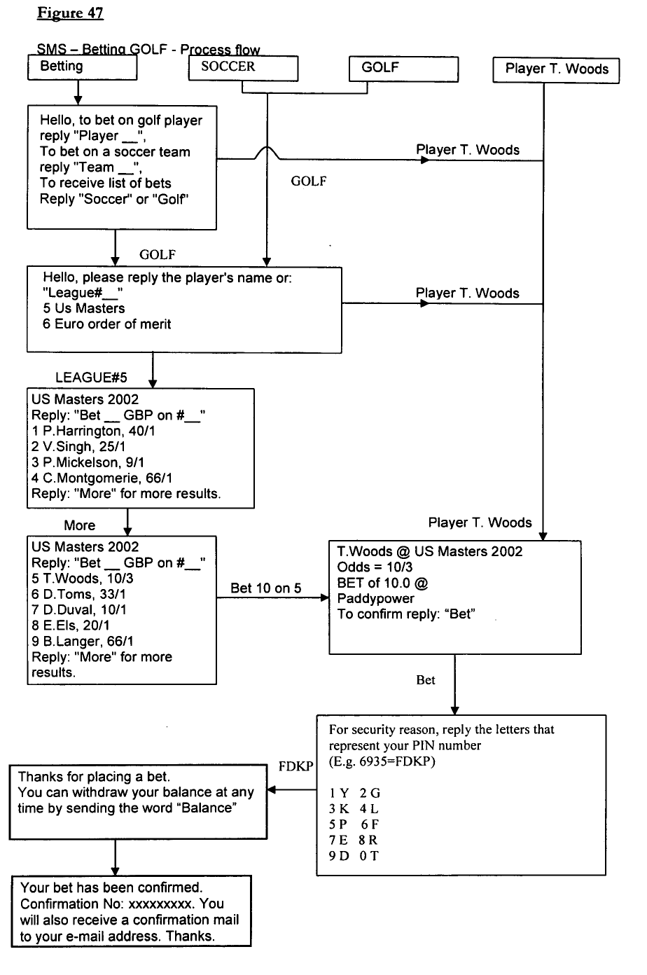

6.3.2 SMS—Betting GOLF—Process flow is shown in FIG. 47.

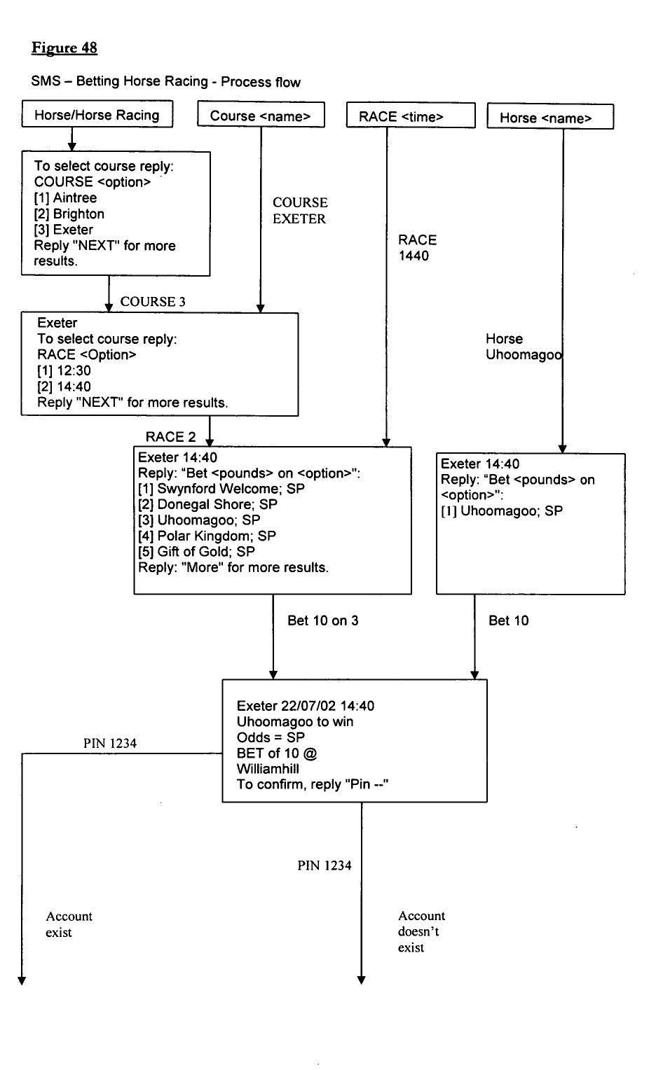

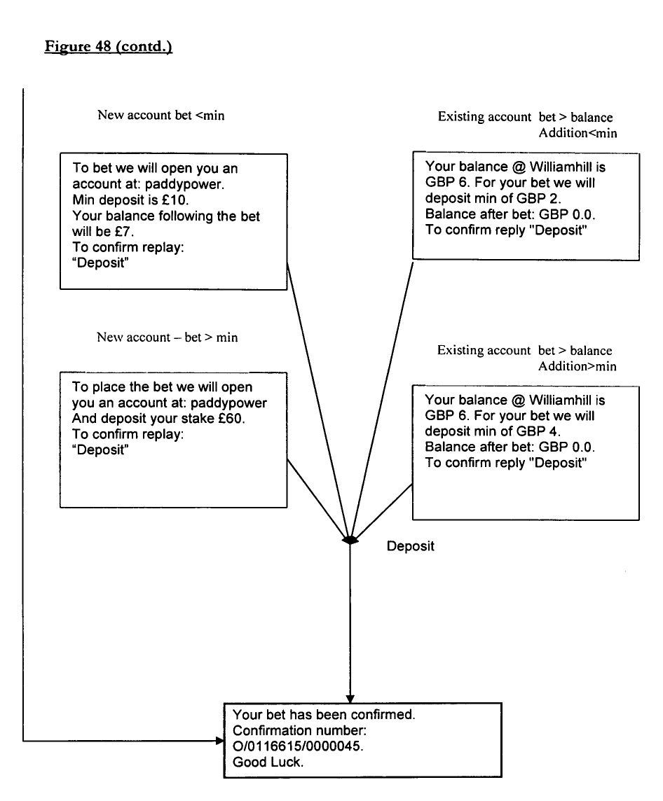

6.3.3 SMS—Betting Horse Racing—Process flow is shown in FIG. 48.

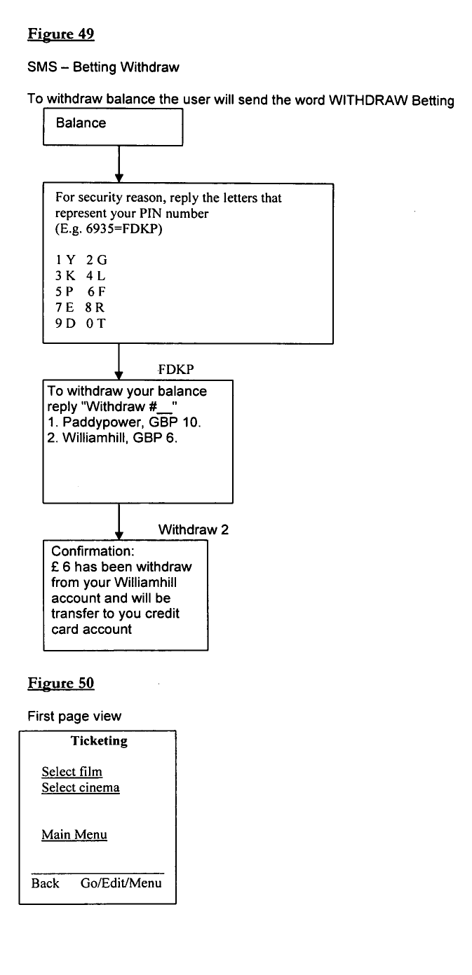

6.3.4 SMS—Betting Withdraw screens are shown in FIG. 49.

7. Functional Specifications—Ticketing.

Search Criteria

Search for the preferred cinema and view available films
Search for the preferred film and view the cinemas that display the film
When selecting a film—search for available time
Define user preferences
Search favourites.

The results of the search will be presented as follow:

Cinema Search
List of cinemas that match the searched key word.

Film Search
List of films that match the searched key word.
   Preferences
The user will be able to select a list of favourite cinemas and perform a search for available films.
   Payment
The user will receive a breakdown of the costs (number of tickets, prices, booking charges)
All cost will be in GBP.
SMS will cover only adult tickets.
   7.1 Ticketing Functionality

7.1.1 First page view is shown in FIG. 50.

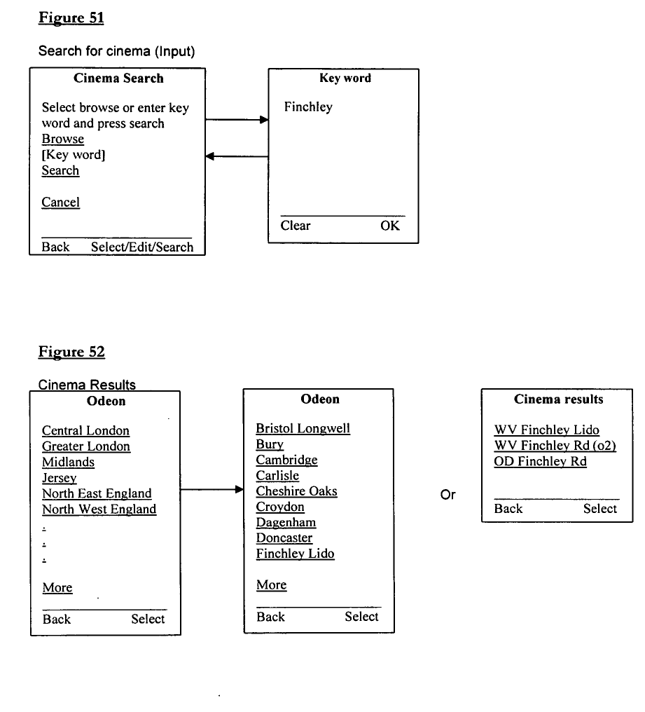

7.1.2 Search for cinema (Input) screens are shown in FIG. 51.

7.1.3 Cinema Results screens are shown in FIG. 52.

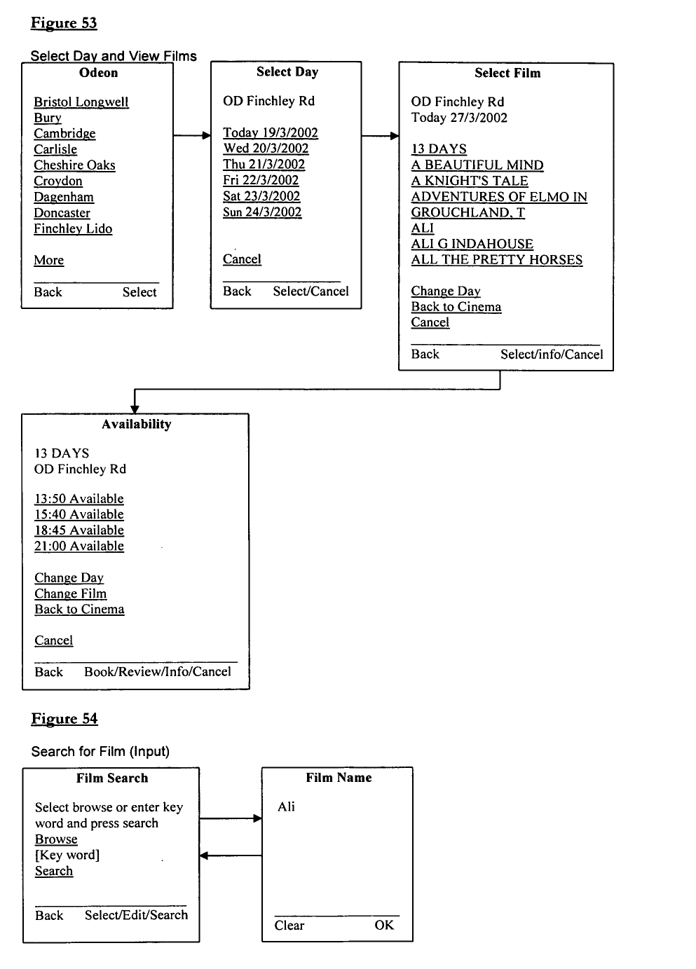

7.1.4 Select Day and View Films screens are shown in FIG. 53.

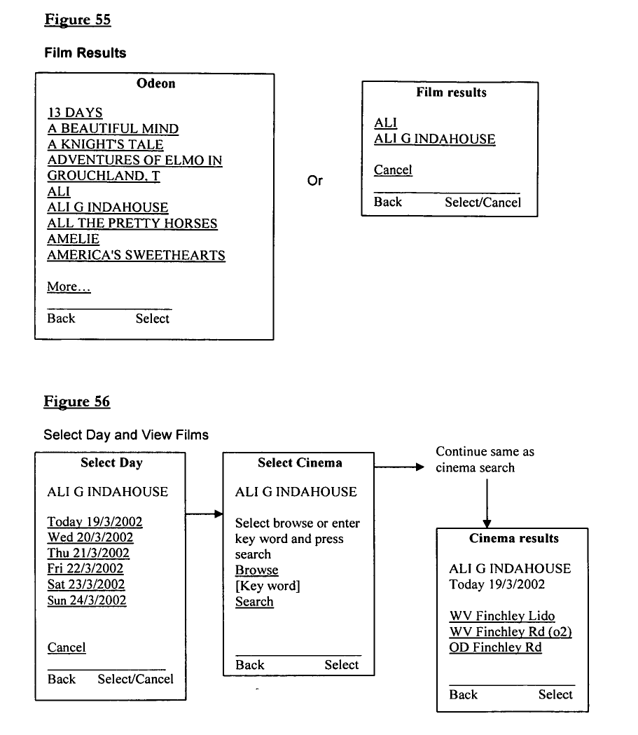

7.1.5 Search for Film (Input) screens are shown in FIG. 54.

7.1.6 Film Results screens are shown in FIG. 55.

7.1.7 Select Day and View Films screens are shown in FIG. 56.

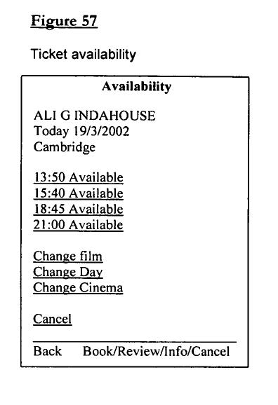

7.1.8 Ticket availability screen is shown in FIG. 57.

7.2 Ticketing—Payment Functionality

The payment functionality will be build out of two-steps.

d. The user will enter his payment pin to start the payment.

e. The user will select the number of ticket he wants to buy from each category.

f. The user will see all the available information from the HTML confirmation page and will enter “Confirm” to complete the process.

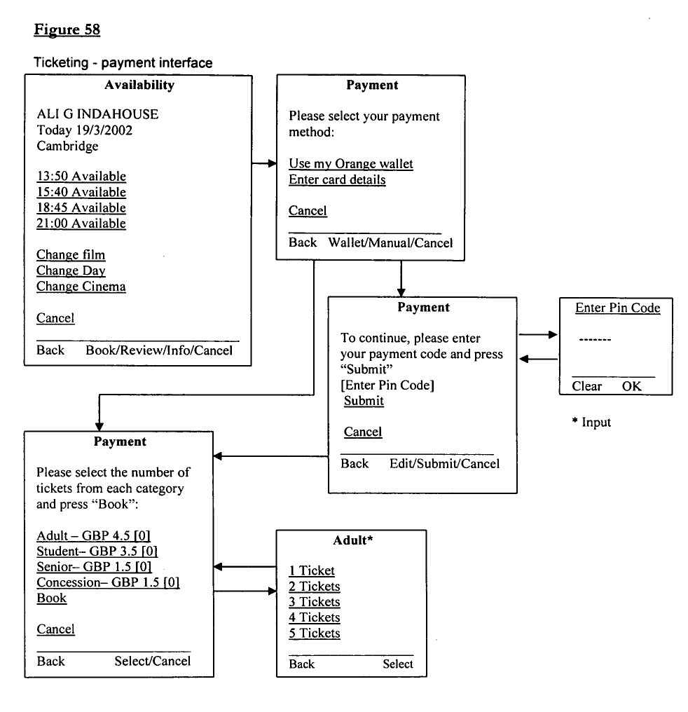

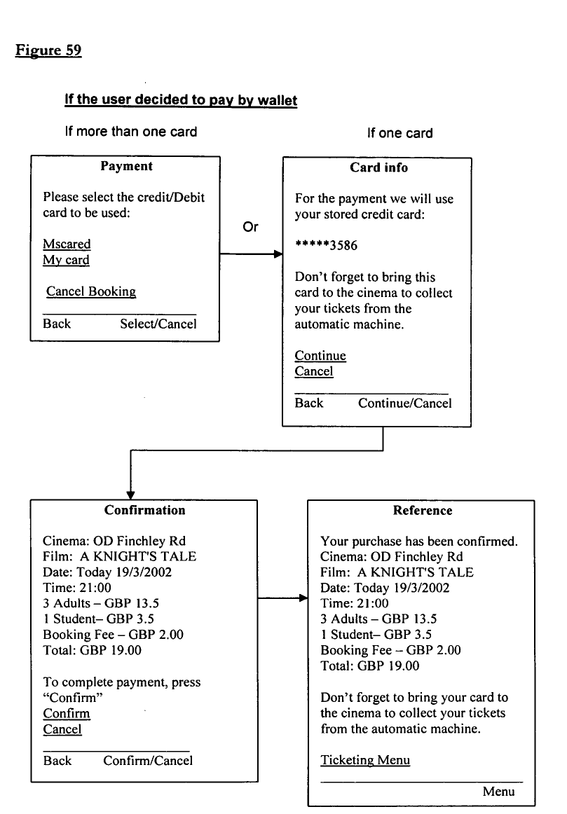

7.2.1 Ticketing—payment interface screens are shown in FIG. 58.

If the user decided to pay by wallet screens are shown in FIG. 59.

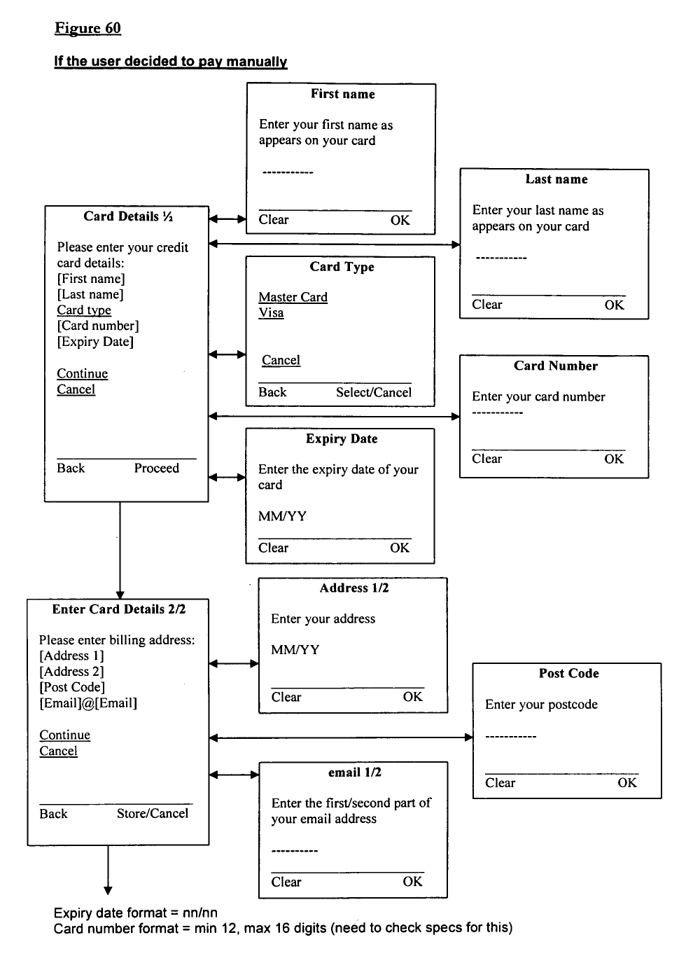

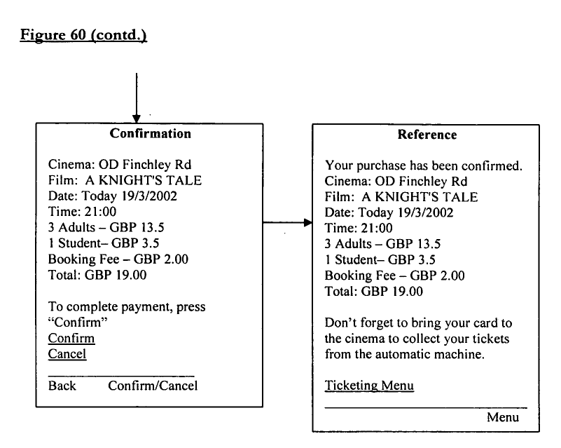

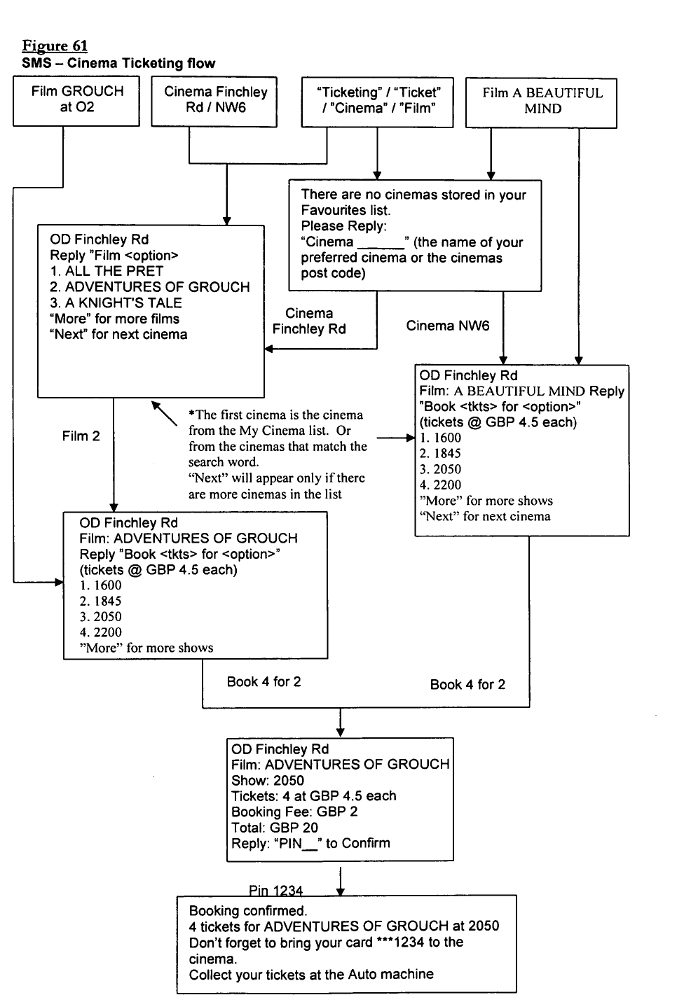

If the user decided to pay manually screens are shown in FIG. 60.

7.3 Ticketing—SMS Format

The SMS interface for Ticketing will be similar to using the Search My cinemas function via WAP.

The user will be able to send name/Number of the cinema in his list or the words Ticket, Ticketing, or Film and will get a reply accordingly. The search will cover the cinemas on his favorites list.

If the user wants to search different cinemas he will send a name for search after the word cinema.

Establish the Communication

The required data to initiate a search contains the following:
“Ticketing”/“Ticket”/“Cinema”/“Film”
“Cinema ______”
“Film ______”.

### Example 1

Received: “Ticketing”/“Ticket”/“Cinema”/“Film”
Reply: OD Finchley Rd
   Reply “Book_for_” GBP 4.5 each
   1. ALL THE PRET
   2. ADVENTURES OF GROUCH
   3. A KNIGHT'S TALE
   “More” for more films
   “Next” for next cinema
Received: Book 4 for 2
Reply: OD Finchley Rd
   Film: ADVENTURES OF GROUCH
   Tickets: 4 at GBP 4.5 each
   Reply “Show_” (number of the show)
   1. 1600
   2.1845
   3.2050
   4. 2200
   “More” for more shows
Received: Show 3
Reply: OD Finchley Rd
   Film: ADVENTURES OF GROUCH
   Show: 2050
   Tickets: 4 at GBP 4.5 each
   Booking Fee: GBP 2
   Total: GBP 20
   Reply: “PIN______” to Confirm
Received: Pin 1234
Reply: booking confirmed.
   4 tickets for ADVENTURES OF GROUCH at 2050
   Don't forget to bring your card ***1234 to the cinema.

Collect your tickets at the Auto machine.

### Example 2

Received: Film Ali.

If there is Morew than one Match
Reply: OD Finchley Rd
   Reply “Book_for_” GBP 4.5 each
   1. Ali
   2. Ali G Indahouse
   “Next” for next cinema
Received: Next
Reply: OD Camden
   Reply “Book_for_” GBP 4.5 each
   1. Ali
   2. Ali G Indahouse.
      If there is only One Match
Reply: OD Finchley Rd
   Film: Ali
   Reply “Book_for_” (number of tickets—GBP 4.5 each at:—)
   1. 1600
   2. 1845
   3.2050
   4. 2200
   “More” for more shows
   “Next” for next cinema
Received: Book 3 for 3
Reply: OD Camden
   Film: Ali
   Show: 2050
   Tickets: 3 at GBP 4.5 each
   Booking Fee: GBP 1.5
   Total: GBP 15
   Reply: “PIN______” to Confirm.

7.3.1 SMS—Cinema Ticketing flow screens are shown in FIG. 61.

1. A system which enables a mobile telephone to be used to locate goods or services, comprising the following elements:
(a) a communications network to allow a mobile telephone operator to receive, from the mobile telephone, criteria defining the goods or services required;
(b) a searching system connected to receive the criteria and perform automated searches against those criteria using resources provided by suppliers of the goods or services and to send results over the communications network to the mobile telephone;
(c) an electronic commerce and billing engine operating to allow the user of the mobile telephone to order goods or services from the operator and not the supplier.

2. The system of claim 1 in which the searching system uses business logic defined by the operator to prioritise or filter search results according to predefined rules set by the operator.

3. The system of claim 1 in which the searching system automatically interrogates web based resources from suppliers to allow a user of the mobile telephone to compare similar goods or services from different suppliers without those suppliers needing to provide wireless protocol specific data.

4. The system of claim 1 in which the searching system automates user defined processes, enabling the user to delegate tasks to the searching system without the need for continued real time connection to the Internet.

5. The system of claim 1 in which the searching system can be modified by user defined preferences or profiles.

6. The system of claim 1 in which the searching system can supply data records defining the details of the process used by customers to look for goods or services to purchase.

7. A method of enabling a mobile telephone to be used to locate goods or services, comprising the following steps:
(a) a mobile telephone operator receiving, from the mobile telephone, criteria defining the goods or services required;
(b) the mobile telephone operator then (i) directly or indirectly obtaining from a supplier information describing one or more goods or services meeting the criteria and providing that information to the mobile telephone and (ii) allowing the user of the mobile telephone to order goods or services directly from it and not the supplier.

8. The method of claim 7 in which the user of the mobile telephone can make a purchase by sending a request to the operator, who in turn completes the purchase transaction with an applicable supplier.

9. The method of claim 7 in which the costs of goods or services purchased are added to a regular bill which includes costs of voice services supplied by the mobile operator to the user of the mobile telephone.

10. The method of claim 7 in which the mobile telephone user sends a request for goods and services using a protocol which is device and bearer agnostic.

11. The method of claim 10 in which the request is directed to the operator, who then routes it through to a server which initiates a web based search through web based resources from appropriate suppliers.
